(19) United States
(12) Patent Application Publication
(10) Pub. No.: US 2008/0281987 A1
(43) Pub. Date: Nov. 13, 2008

(54) FACILITATING AUTOMATIC PROTECTION SWITCHING FOR PROVIDER BACKBONE NETWORK

(75) Inventors: Darek Skalecki, Kanata (CA); Geraldine Civil, Nepean (CA); Dinesh Mohan, Kanata (CA)

Correspondence Address: RIDOUT & MAYBEE LLP, 225 KING STREET WEST, 10TH FLOOR, TORONTO, ON, M5V 3M2, CA

(73) Assignee: NORTEL NETWORKS LIMITED, St. Laurent (CA)

(21) Appl. No.: 11/773,745

(22) Filed: Jul. 5, 2007

Related U.S. Application Data
(60) Provisional application No. 60/917,124, filed on May 10, 2007.

(51) Int. Cl. G06F 15/16

(52) U.S. Cl. 709/253

(57) ABSTRACT

An existing protection mechanism is enhanced through the use of an automatic protection switching protocol data unit (APS PDU). In conjunction with transmitting Ethernet frames to a second bridge over a primary path, a first bridge transmits APS PDUs to the second bridge over a secondary path. The APS PDUs provide the second bridge with information about the protection switching mechanism being used and provide indications regarding the status of the primary path. In particular, protection switching may be facilitated by forming an APS PDU that is extended to include an indication of an identity for a trunk or a primary path before transmitting the APS PDU to the second bridge. Alternatively, after forming a regular APS PDU, protection switching may be facilitated by encapsulating the regular APS PDU with information identifying a trunk or a primary path before transmitting the APS PDU to the second bridge.

### CROSS REFERENCE TO RELATED APPLICATIONS

The present application claims priority to U.S. Provisional Patent Application Ser. No. 60/917,124, filed May 10, 2007, the contents of which are hereby incorporated herein by reference.

### FIELD OF THE INVENTION

The present application relates generally to protection switching and, more specifically, to facilitating automatic protection switching for a Provider Backbone network.

### BACKGROUND OF THE INVENTION

Provider Backbone Transport (PBT) offers a mechanism to permit scalable point-to-point tunnels to be configured or signaled in an Ethernet subnetwork. Advantageously, PBT provides a set of enhancements to Ethernet technology that allow use of Ethernet in a carrier class transport network. PBT uses concepts of Virtual Local Area Network (VLAN) tagging as provided in the Institute for Electrical and Electronics Engineers (IEEE) standard 802.1Q, stacked VLANs as provided in the IEEE standard 802.1ad and Provider Backbone Bridges as provided in IEEE 802.1ah. Additionally, PBT does without known Ethernet aspects such as flooding or broadcasting and the spanning tree protocol. Beneficially, the set of Ethernet standards is enhanced for use in connection-oriented networks.

A bridge operating according to PBT, forwards a given frame based on an outer VLAN ID (VID) and a Media Access Control Destination Address (i.e., a MAC DA) as identified in a header of the given frame. The aspect of Ethernet known as MAC learning is disabled in bridges operating according to PBT so that the forwarding of a received frame is based on a Filter Database (FDB) that is configured via a management plane or a control plane.

Path protection is provided by using one “working”, or “primary”, path and one “protection”, or “secondary”, path between a pair of end point bridges. There may be zero or more transit bridges in between the end point bridges. For each traffic direction, one VID is associated with the primary path and a distinct VID is associated with the secondary path. The primary path VID is included in the header of each Ethernet frame that is to be transmitted between the end point bridges over the primary path. Similarly, the secondary path VID is included in the header of each Ethernet frame that is to be transmitted between the end point bridges over the secondary path. According to the IEEE standard 802.1ag, continuity check messages (CCMs) are periodically transmitted between the end point bridges over both the primary and secondary paths. These CCMs help detect failures along the paths. When one end point bridge stops receiving CCMs from the other end point bridge along one of the two paths for a given period of time then that path is deemed failed. When a primary path fails and this path was currently active, i.e., carrying all Ethernet traffic, then the end point bridge that detects the failure negotiates a protection switch with the other end point bridge. When such negotiation succeeds, then both bridges start transmitting all Ethernet traffic along the secondary path, i.e., the secondary path becomes the active path.

### SUMMARY

An existing protection switching mechanism is enhanced through an extension to the automatic protection switching protocol data unit (APS PDU). Alternatively, an existing protection switching mechanism is enhanced by encapsulating the existing APS PDU with an I-SID that permits the receiving end point bridge to differentiate such an encapsulated APS PDU from data frames belonging to customer flows being transported. In conjunction with transmitting Ethernet frames over the primary path or the secondary path, the end point bridges also exchange APS PDUs over the secondary path. The APS PDUs provide the receiving end point bridge with protection switching status present at the transmitting end point bridge. This information enables the end point bridges to make a symmetric decision as to whether all customer flow traffic should be transported over the primary path or the secondary path in both directions.

According to an aspect of the present invention, there is provided, at a first bridge at a first end point of a trunk, a method of facilitating protection switching. The method includes composing an automatic protection switching protocol data unit (APS PDU), the APS PDU including an indication of an identity for the trunk and transmitting the APS PDU to a second bridge at a second end point of the trunk over a secondary path to the second bridge. In other aspects of the present application, a first bridge at a first end point of a trunk is provided for carrying out this method and a computer readable medium is provided for adapting a processor in a first bridge at a first end point of a trunk to carry out this method.

According to another aspect of the present invention, there is provided, at a first bridge at a first end point of a trunk, the trunk having a primary path and a secondary path to a second bridge at a second end point of the trunk, a method of facilitating protection switching. The method includes composing an automatic protection switching protocol data unit (APS PDU), the APS PDU including an indication of the primary path and transmitting the APS PDU to the second bridge over the secondary path.

According to a further aspect of the present invention, there is provided, at a first bridge at a first end point of a trunk, a method of facilitating protection switching. The method includes composing an automatic protection switching protocol data unit (APS PDU), encapsulating the APS PDU with a Service Instance Tag, thereby creating an encapsulated APS PDU, where the Service Instance Tag includes an indication of an identity for the trunk and transmitting the encapsulated APS PDU to a second bridge at a second end point of the trunk over a secondary path to the second bridge.

According to a still further aspect of the present invention, there is provided, at a first bridge at a first end point of a trunk, the trunk having a primary path and a secondary path to a second bridge at a second end point of the trunk, a method of facilitating protection switching. The method includes composing an automatic protection switching protocol data unit (APS PDU), encapsulating the APS PDU with a Service Instance Tag, thereby creating an encapsulated APS PDU, where the Service Instance Tag includes an indication of an identity for the primary path and transmitting the encapsulated APS PDU to a second bridge at a second end point of the trunk over a secondary path to the second bridge.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made to the drawings, which show by way of example, embodiments of the invention, and in which:

FIG. 1A illustrates a network configured so that a first trunk is associated with a primary path and a secondary path;

FIG. 1B illustrates a network configured so that a second trunk is associated with a primary path and a secondary path;

FIG. 2 illustrates the present layout for an APS PDU including a field for APS specific information;

FIG. 3 illustrates the present layout for the APS specific information in the APS PDU layout of FIG. 2;

FIG. 4 illustrates a network configured so that two trunks share paths;

FIG. 5 illustrates a novel layout for an extended version of the APS PDU of FIG. 2 according to an embodiment of the present invention;

FIG. 6 illustrates steps of an example method of facilitating protection switching according to an embodiment of the present invention;

FIG. 7 illustrates a network having N trunks carried by N primary paths, where the N trunks share a single secondary path, i.e. one secondary path protecting N primary paths or 1:N protection;

FIG. 8 illustrates a network having a single trunk carried by N primary paths, where the trunk has a single secondary path, i.e. one secondary path protecting N primary paths or 1:N protection;

FIG. 9 illustrates an example format for an I-TAG; and

FIG. 10 illustrates steps in an example method of facilitating protection switching according to another embodiment of the present invention.

### DETAILED DESCRIPTION OF THE EMBODIMENTS

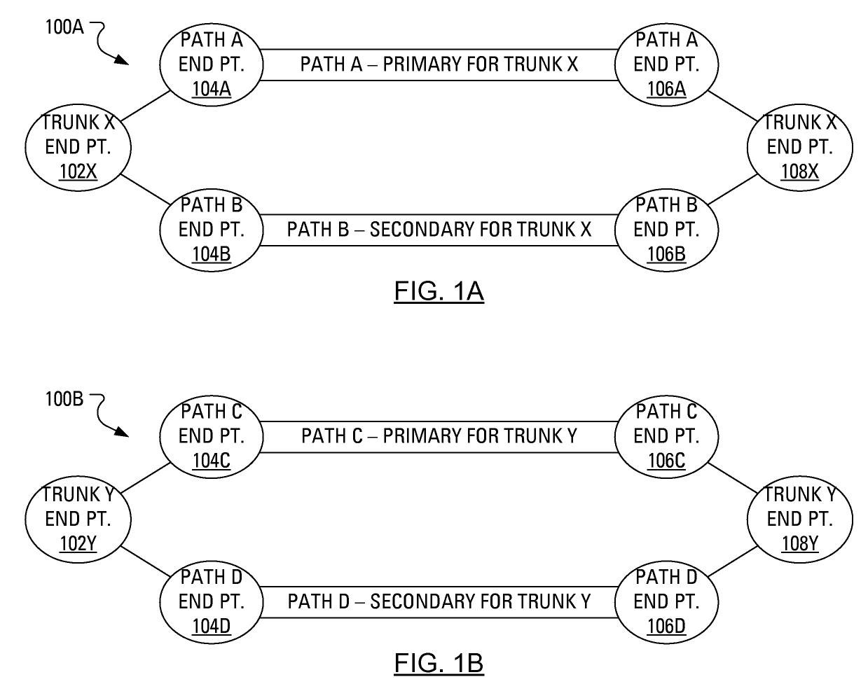

FIG. 1A illustrates a network 100A having two identified paths: a path A, extending between a first path A end point 104A and a second path A end point 106A; and a path B, extending between a first path B end point 104B and a second path B end point 106B. The paths A and B may be used in a protection switching mechanism for a connection (called “trunk X”) between a first trunk X end point 102X and a second trunk X end point 108X. In particular, in operation, path A may be designated as the primary path for trunk X and path B may be designated as the secondary path for trunk X.

The end points 102X, 104A, 104B, 106A, 106B and 108X, indeed all the end points used in networks described herein, are expected to physically or virtually have components typical in such networks. That is, a generic bridge comprising end points 102X, 104A, 104B or 106A, 106B, 108X has at least one input port, at least one output port, a processor for directing traffic between the input and the output ports and a memory for storing instructions and data used by the processor in operation. The instructions may be loaded on the memory from a disk, a tape, a chip or a random access memory containing a file downloaded from a remote source.

Similarly, FIG. 1B illustrates a network 100B having two identified paths: a path C, extending between a first path C end point 104C and a second path C end point 106C; and a path D, extending between a first path D end point 104D and a second path D end point 106D. The paths C and D may be used in a protection switching mechanism for a connection (called “trunk Y”) between a first trunk Y end point 102Y and a second trunk Y end point 108Y. In particular, in operation, path C may be designated as the primary path for trunk Y and path D may be designated as the secondary path for trunk Y.

The telecommunication standardization sector of the International Telecommunications Union (ITU) has published Recommendation G.8031/Y.1342, which specifies linear protection switching mechanisms to be applied to VLAN-based Ethernet networks as described in ITU-T Recommendation G.8010/Y.1306. Protection switching is a fully allocated survivability mechanism. It is fully allocated in the sense that the route and bandwidth of the protection entity is reserved for a selected working entity. Protection switching provides a fast and simple survivability mechanism. It is easier for the network operator to grasp the status of the network (e.g., active network topology) with a protection switching mechanism than with other survivability mechanisms such as the known Rapid Spanning Tree Protocol.

ITU-T Recommendation Y.1731 provides definitions for each Protocol Data Unit (PDU) that may be employed for Ethernet Operation, Administration, and Maintenance (OAM), thereby providing a suite of Ethernet OAM PDUs. In a network employing protection switching, OAM PDUs are sent along the secondary path. For instance, in FIG. 1A, OAM PDUs are sent between the first trunk X end point 102X and the second trunk X end point 108X over path B. That is, the OAM PDUs are sent between the first path B end point 104B and the second path B end point 106B.

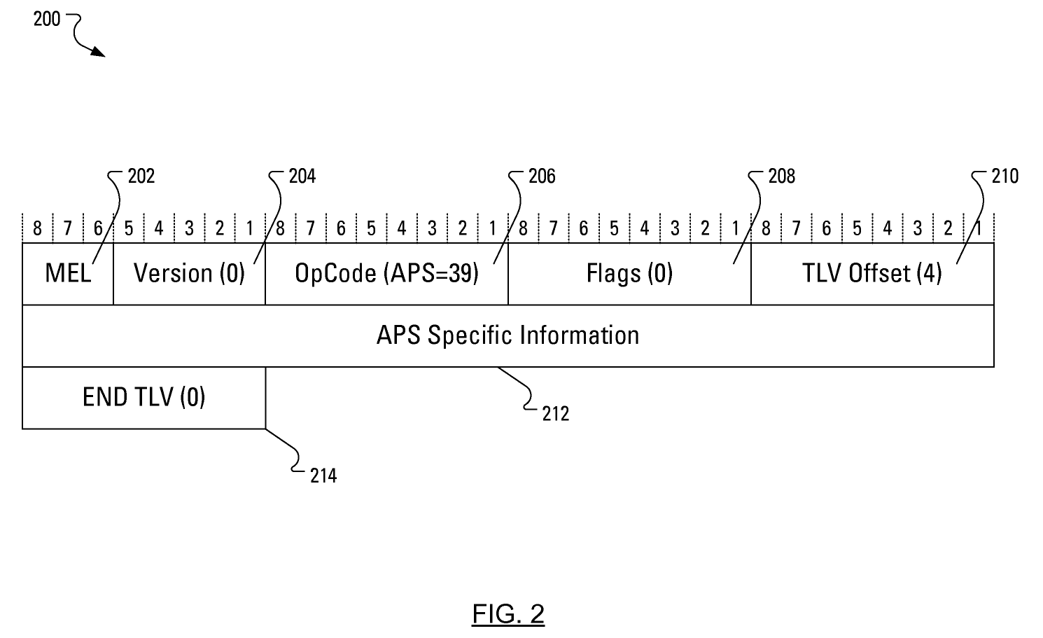

Among the PDUs in the Ethernet OAM suite of PDUs is a PDU specific to Automatic Protection Switching (APS) 200 (see FIG. 2). APS-specific information is transmitted within specific fields in the APS PDU 200. The APS PDU 200 includes: a MEL field 202 in which a value is inserted for a level of a Maintenance Entity Group; a Version field 204; an OpCode field 206; a field 208 for Flags; at Type-Length-Value (TLV) Offset field 210; a field 212 for specific APS information; and a field 214 for an END TLV.

The APS PDU, which may also be called an “EthAPS frame”, is identified by a specific Ethernet OAM OpCode (0x39). APS-specific information is carried in the APS PDU 200 in the APS information field 212, which, as illustrated in FIG. 2, is a four octet field. In addition, it should be noted that, for the current version of Recommendation G.8031/Y.1342, the TLV Offset field 210 is required to be set to 0x04.

For other fields, such as the Version field 202, the Flags field 208 and the END TLV field 214, the following values shall be used, as defined in ITU-T Recommendation Y.1731: Version, 0x00; Flags, 0x00; and END TLV, 0x00.

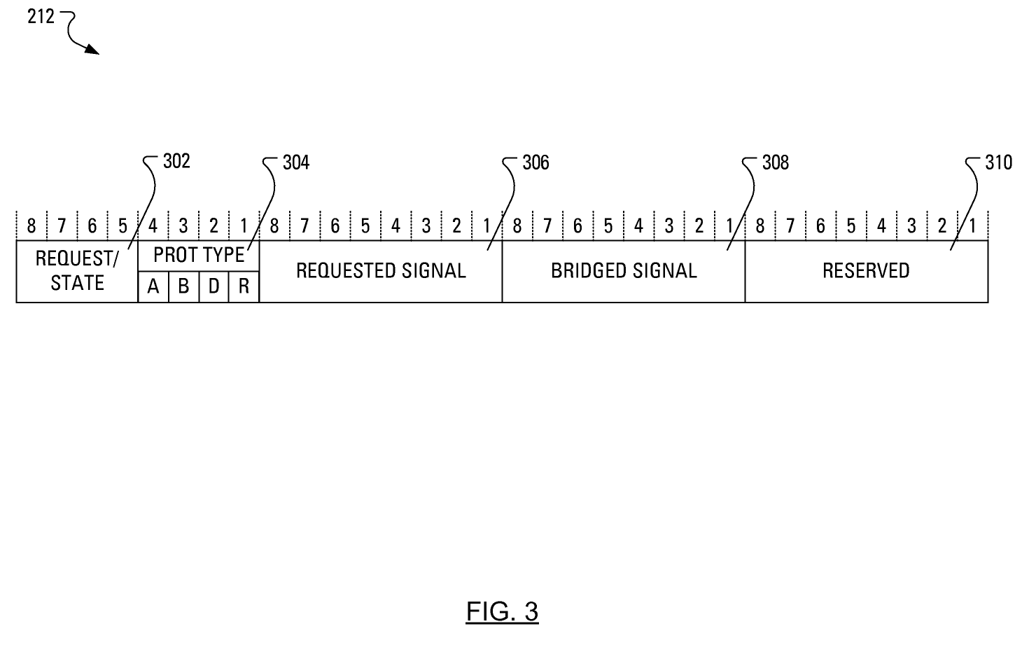

An example format of the APS-specific information in the APS information field 212 of each APS PDU 200 is illustrated in FIG. 3 to include: a Request/State filed 302; a Protection Type field 304; a Requested Signal field 306; a Bridged Signal field 308 and a Reserved field 310. Valid contents for these fields are provided in the following table:

| | | | |
|---|---|---|---|
| Request/State | 1111 | Lockout of protection (LO) | Priority |
| | 1110 | Signal Fail For Protection (SF-P) | Highest |
| | 1101 | Forced Switch (FS) | |
| | 1011 | Signal Fail for Working (SF) | |
| | 1001 | Signal Degrade (SD) (note 1) | |
| | 0111 | Manual Switch (MS) | |
| | 0101 | Wait to Restore (WTR) | |
| | 0100 | Exercise (EXER) | |
| | 0010 | Reverse Request (RR) | |
| | 0001 | Do Not Revert (DNR) | |
| | 0000 | No Request (NR) | Lowest |

| | | Others | Reserved for future international |
|---|---|---|---|
| | | | standardization |
| Protection | A | 0 | No APS Channel |
| Type | | 1 | APS Channel |
| | B | 0 | 1 + 1 (Permanent Bridge) |
| | | 1 | 1:1 (no Permanent Bridge) |
| | D | 0 | Unidirectional switching |
| | | 1 | Bidirectional switching |
| | R | 0 | Non-revertive operation |
| | | 1 | Revertive operation |

| | | |
|---|---|---|
| Requested | 0 | Null Signal |
| Signal | 1 | Normal Traffic Signal |
| | 2-255 | (Reserved for future use) |
| Bridged Signal | 0 | Null Signal |
| | 1 | Normal Traffic Signal |
| | 2-255 | (Reserved for future use) |

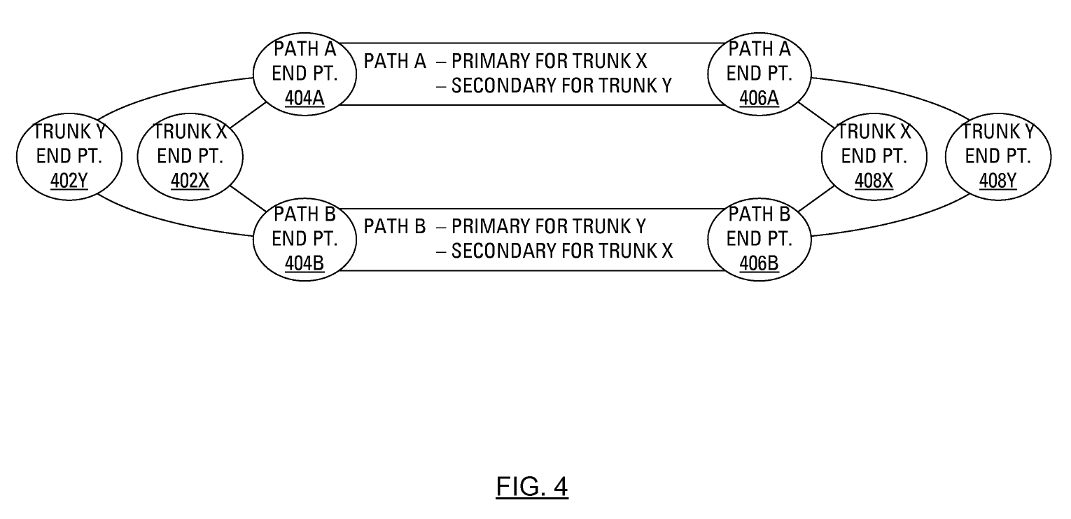

(note 1) - SD is for further study.
Note 2
RR is reserved for future standardization by ITU-T.

Where FIGS. 1A and 1B illustrated networks implementing 1:1 protection without load/capacity sharing, FIG. 4 illustrates a network implementing 1:1 protection with load/capacity sharing. In particular, FIG. 4 illustrates a network 400 having two identified paths: a path A, extending between a first path A end point 404A and a second path A end point 406A; and a path B, extending between a first path B end point 404B and a second path B end point 406B. The paths A and B may be used in a protection switching mechanism for two connections: a connection called “trunk X” between a first trunk X end point 402X and a second trunk X end point 408X; and a connection called “trunk Y” between a first trunk Y end point 402Y and a second trunk Y end point 408Y. In particular, in operation, path A may be designated as the primary path for trunk X and path B may be designated as the secondary path for trunk X. At the same time, path A may be designated as the secondary path for trunk Y and path B may be designated as the primary path for trunk Y. Thus, both paths A and B are designated as primary as well as secondary. That is, one path serves as the backup path for the other and both carry traffic simultaneously under no fault condition. When a fault occurs, one path carries its own load as well as the load of the failed path and thus the name of 1:1 protection with load/capacity sharing.

The format for APS PDUs described above provides no mechanism to identify a 1:1 protected trunk. That is, in the case of the network 400 of FIG. 4, the second path B end point 406B may receive an APS PDU from the first path B end point 404B and it will be unclear whether the APS PDU belongs to trunk X or to trunk Y. If the APS PDU belongs to trunk X then the second trunk X end point 408X should process the request carried in the APS PDU. If the APS PDU belongs to trunk Y then the second trunk Y end point 408Y should recognize that there is a configuration mismatch between the two end points of trunk Y. In which case, the second trunk Y end point 408Y should raise a Configuration Mismatch alarm.

In overview, the frame format for APS PDUs may be extended so that the frames carry the identity of a 1:1 protected trunk.

In particular, in one embodiment, APS PDUs are configured to carry the identity of the 1:1 protected trunk (trunk X or trunk Y) for easy correlation of APS PDUs to trunks.

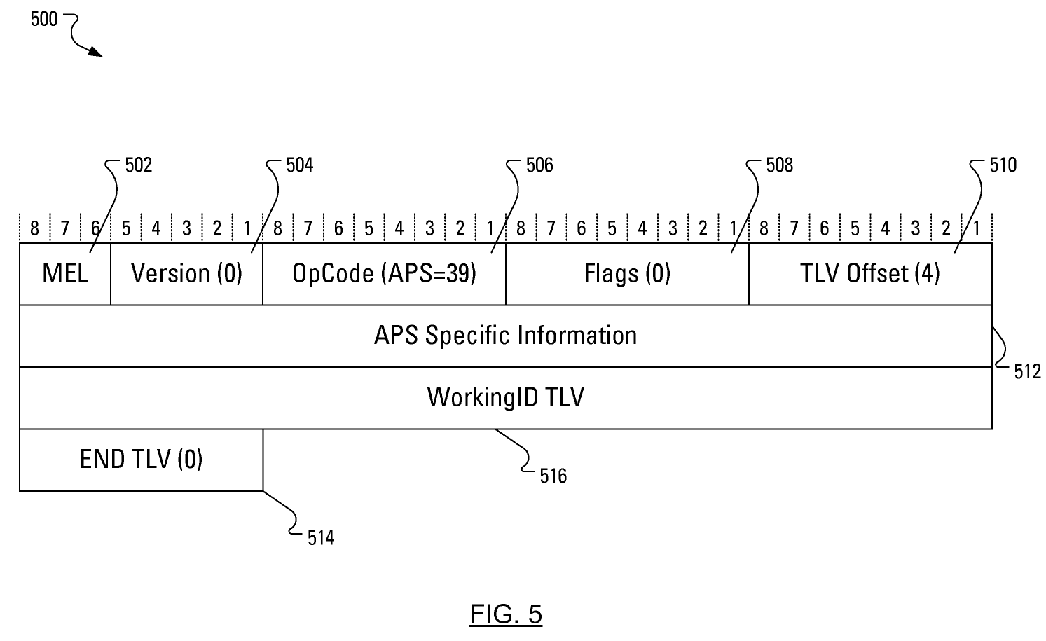

An extended APS PDU 500 is illustrated in FIG. 5. In common with the APS PDU 200 of FIG. 2, the extended APS PDU 500 of FIG. 5 includes: a MEL field 502; a Version field 504; an OpCode field 506; a Flags field 508; at TLV Offset field 510; an APS-specific information field 512; and an END TLV field 514. In contrast to the APS PDU 200 of FIG. 2, the extended APS PDU 500 of FIG. 5 includes a WorkingID TLV field 516.

The WorkingID TLV field 516 may, for instance, carry enough information to identify the trunk to which the extended APS PDU 500 relates.

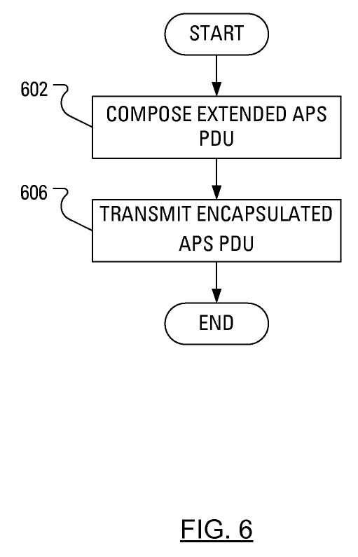

Steps of an example method of facilitating protection switching in the network 400 of FIG. 4 are illustrated in FIG. 6. In one embodiment a trunk end point composes an extended APS PDU related to the trunk (step 602). For instance, the extended APS PDU may be composed according to the example format 500 of FIG. 5.

As part of composing the extended APS PDU, the trunk end point sets the WorkingID TLV of the extended APS PDU to identify the trunk. The trunk end point then transmits (step 606) the extended APS PDU to the far end trunk end point over the trunk's secondary path. The trunk identifier that is set in the WorkingID TLV could be some user configured 32-bit identifier for the trunk. Note that such trunk identifiers would have to be the same on both ends of the trunk.

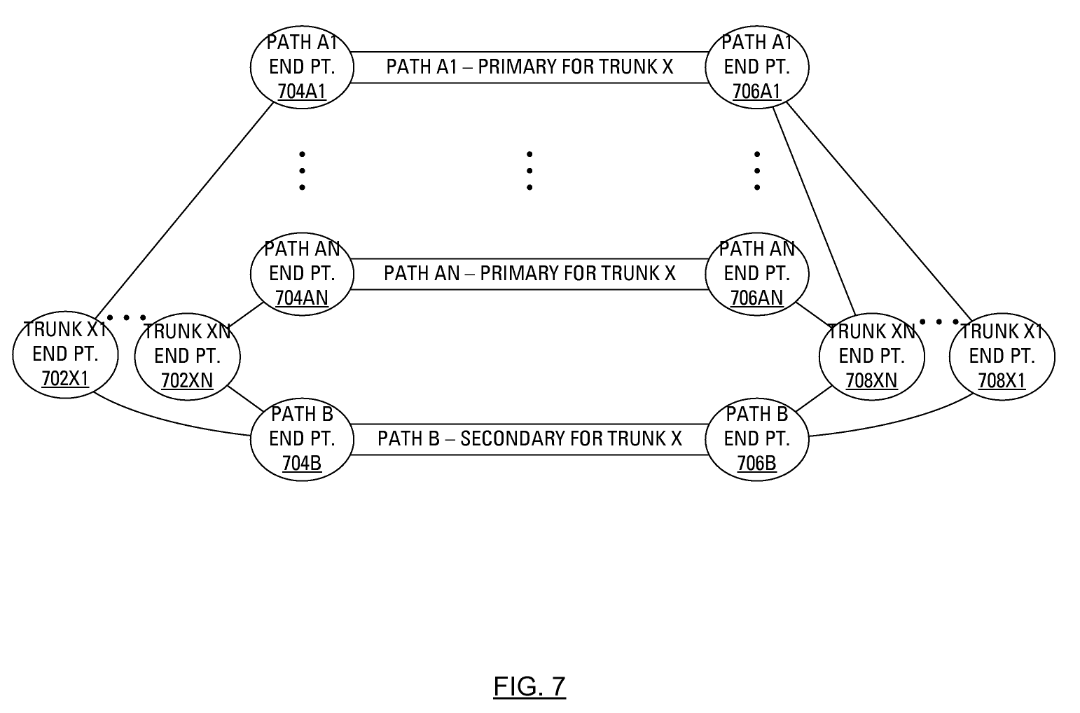

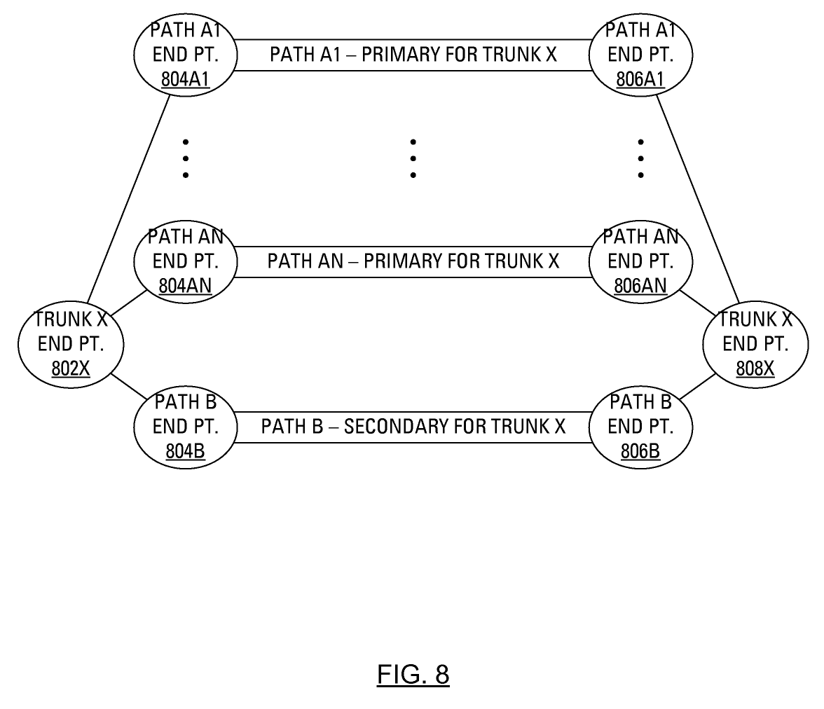

FIG. 7 and FIG. 8 are two alternative ways of modeling 1:N protection.

While identifying the trunk in the extended APS PDU may be suitable in the 1:1 protection case, it has been contemplated that identifying the trunk is insufficient in the 1:N protection case 1:N protection may be implemented in more than one configuration. For example, in a network 700 illustrated in FIG. 7, 1:N protection is implemented using N 1:1 protections. That is, there are N 1:1 protected trunks, each trunk having a separate primary path but a common secondary path.

In particular, FIG. 7 illustrates the network 700 as having N+1 identified paths: a path A1, extending between a first path A1 end point 704A1 and a second path A1 end point 706A1; several paths A2 to A(N−1) (not shown); a path AN, extending between a first path AN end point 704AN and a second path AN end point 706AN; and a path B, extending between a first path B end point 704B and a second path B end point 706B. The paths A1 and B may be used in a protection switching mechanism for a connection labeled “trunk X1” between a first trunk X1 end point 702X1 and a second trunk X1 end point 708X1. Similarly, the paths AN and B may be used in a protection switching mechanism for a connection labeled “trunk XN” between a first trunk XN end point 702XN and a second trunk XN end point 708XN. Equally, though not shown, paths Ay and B may be used in a protection switching mechanism for “trunk Xy”, where y=2 . . . N−1.

Reviewing the suitability of the identification of trunks, in the WorkingID TLV field 516 of the APS PDU as proposed above, in view of the network 700 of FIG. 7, no immediate difficulties are evident. However, there is at least one alternative configuration available for implementing 1:N protection switching.

Consider FIG. 8, which illustrates a network 800 as having N+1 identified paths: a path A1, extending between a first path A1 end point 804A1 and a second path A1 end point 806A1; several paths A2 to A(N−1) (not shown); a path AN, extending between a first path AN end point 804AN and a second path AN end point 806AN; and a path B, extending between a first path B end point 804B and a second path B end point 806B. The paths A1 to AN and B may be used in a protection switching mechanism for a connection called “trunk X” between a first trunk X end point 802X and a second trunk X end point 808X. In particular, in operation, path A1 may be designated as a first primary path for trunk X, path A2 (not shown) may be designated as a second primary path for trunk X, path AN may be designated as an Nth primary path for trunk X, and path B may be designated as the secondary path for trunk X.

Reviewing the suitability of the identification of trunks, in the WorkingID TLV field 516 of the APS PDU as proposed above, in view of the network 800 of FIG. 8, difficulties are evident. For example, consider the receipt, by the second trunk X end point 808X from the second path B end point 806B, of an APS PDU that identifies trunk X in the WorkingID TLV field 516. The received APS PDU may, for example, include the code 1011 in the request/state field 302 indicating a Signal Failure. However, since the contents of the WorkingID TLV field 516 only identifies trunk X, it is unclear to the second trunk X end point 808X which path's (A1 . . . AN) traffic is to be switched to path B.

In an alternative embodiment, the contents of the WorkingID TLV field 516 identify the primary path. For example, consider the receipt, by the second trunk X end point 808X from the second path B end point 806B, of an APS PDU that identifies path A1 in the WorkingID TLV field 516. The received APS PDU may, for example, include the code 1011 in the request/state field 302 indicating a Signal Failure. Since the contents of the WorkingID TLV field 516 identifies path A1, it is clear to the second trunk X end point 808X that path A1 traffic is to be switched to path B.

For PBT, a particular primary path may be identified using a combination of Backbone Media Access Control Destination Address (B-MAC DA) and Backbone VLAN ID (B-VID). Since B-MAC DA for all paths A1 to AN and B is the same, then identification for these paths must differ in the B-VID and, thus, B-VID is a good choice for path identifier within WorkingID TLV.

In a distinct approach, rather than extending the APS PDU as illustrated in FIG. 5, each APS PDU is encapsulated in such a way that primary path can be deduced. In one embodiment, concepts being developed in conjunction with the Institute for Electrical and Electronics Engineers (IEEE) 802.1ah standard. The 802.1ah standard is known to relate to Provider Backbone Bridges (PBB) (A.K.A. “Mac-in-Mac”, or “MinM”). PBB allows for layering of an Ethernet network into customer domains and provider domains with complete isolation among respective MAC addresses. PBB defines a Backbone Media Access Control Destination Address (B-MAC DA) and a Backbone Media Access Control Source Address (B-MAC SA). PBB also defines acronyms such as B-VID (Backbone VLAN ID), I-SID (Service Instance ID) and I-TAG (Service Instance Tag).

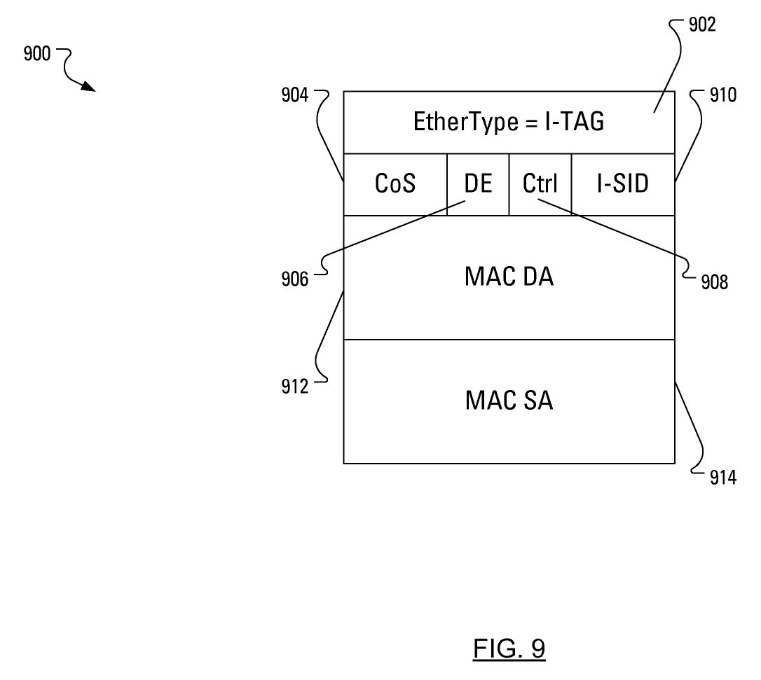

A format for an I-TAG 900 is illustrated in FIG. 9 as including: an EtherType field 902 wherein the value of I-TAG identifies this Ethernet frame as I-TAG; a Class of Service (CoS) field 904, in which a priority may be assigned to the tagged PDU; a Drop Eligibility (DE) field 906, in which an importance may be assigned to the tagged PDU; a Ctrl field 908 for version information and various flags; a Service Instance ID (I-SID) field 910; a MAC Destination Address (DA) field 912; and a MAC Source Address (SA) field 914.

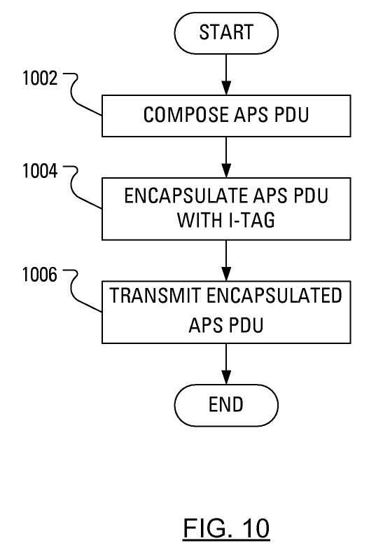

Steps of an example method of facilitating protection switching in the network 400 of FIG. 4 are illustrated in FIG. 10. In one embodiment, a trunk end point composes an APS PDU related to the trunk (step 1002). The trunk end point then encapsulates the APS PDU (step 1004) with an I-TAG. The trunk end point sets the I-TAG to include a special I-SID in the I-SID field 910. The special I-SID identifies the trunk. The trunk end point then transmits (step 1006) the I-TAG-encapsulated APS PDU to the far end trunk end point over the trunk's secondary path.

In view of future requirements for 1:N protection switching, rather than identifying a trunk by way of a special I-SID, a primary path may be identified by way of a special I-SID. For example, the first trunk X end point 802X of FIG. 8 may compose an APS PDU (step 1002) and encapsulate the APS PDU (step 1004) with an I-TAG that includes a special I-SID in the I-SID field 910, where the special I-SID identifies path A1. The first trunk X end point 802X may then transmit the encapsulated APS PDU to the first path B end point 804B for further transmission to the second trunk X end point 808X over path B.

In another embodiment, when a trunk end point encapsulates the APS PDU (step 1004), the trunk end point sets the I-TAG to include a combination of a real service I-SID in the I-SID field 910, a special MAC DA in the MAC DA field 912 and a special MAC SA in the MAC SA field 914. The real service I-SID, the special MAC DA and the special MAC SA combine to distinctly identify, in one embodiment, the trunk X. Alternatively, in another embodiment, the real service I-SID, the special MAC DA and the special MAC SA combine to distinctly identify the primary path for trunk X.

Note that the difference between the real service I-SID and a special I-SID is that a special I-SID, once configured for protection switching purposes for a particular trunk, cannot then be used for transport of a real customer flow traffic. That is, the special I-SID can solely be used to identify APS PDUs. In contrast, when a real service I-SID is used, then a special MAC DA and SA need to be used to differentiate trunk level APS PDUs from service level APS PDUs.

The above-described embodiments of the present application are intended to be examples only. Alterations, modifications and variations may be effected to the particular embodiments by those skilled in the art without departing from the scope of the application, which is defined by the claims appended hereto.

What is claimed is:

1. At a first bridge at a first end point of a trunk, a method of facilitating protection switching comprising:
composing an automatic protection switching protocol data unit (APS PDU), said APS PDU including an indication of an identity for said trunk; and
transmitting said APS PDU to a second bridge at a second end point of said trunk over a secondary path to said second bridge.

2. The method of claim 1 wherein said APS PDU has a format based on a format described in International Telecommunications Union Recommendation G.8031/Y.1342.

3. The method of claim 2 wherein said APS PDU has an additional Type-Length-Value (TLV) field, where said additional TLV field carries said indication of said identity for said trunk.

4. The method of claim 1 wherein said trunk is a Provider Backbone Transport trunk.

5. A first bridge at a first end point of a trunk, said bridge for facilitating protection switching, said bridge comprising:
a processor adapted to:
compose an automatic protection switching protocol data unit (APS PDU), said APS PDU including an indication of an identity for said trunk; and
transmit said APS PDU to a second bridge at a second end point of said trunk over a secondary path to said second bridge.

6. A computer readable medium containing computer-executable instructions that, when performed by processor in a bridge, cause said processor to:
compose an automatic protection switching protocol data unit (APS PDU), said APS PDU including an indication of an identity for said trunk; and
transmit said APS PDU to a second bridge at a second end point of said trunk over a secondary path to said second bridge.

7. At a first bridge at a first end point of a trunk, said trunk having a primary path and a secondary path to a second bridge at a second end point of said trunk, a method of facilitating protection switching comprising:
composing an automatic protection switching protocol data unit (APS PDU), said APS PDU including an indication of said primary path; and
transmitting said APS PDU to said second bridge over said secondary path.

8. The method of claim 7 wherein said indication of said primary path comprises a backbone media access control destination address (B-MAC DA) and a Virtual Local Area Network Identifier (VLAN ID).

9. At a first bridge at a first end point of a trunk, a method of facilitating protection switching comprising:
composing an automatic protection switching protocol data unit (APS PDU);
encapsulating said APS PDU with a Service Instance Tag (I-TAG), thereby creating an encapsulated APS PDU, where said Service Instance Tag includes an indication of an identity for said trunk; and
transmitting said encapsulated APS PDU to a second bridge at a second end point of said trunk over a secondary path to said second bridge.

10. The method of claim 9 wherein said indication of said identity for said trunk is a special Service Instance Virtual Identifier (I-SID), where special Service Instance Identifier (I-SID) can solely be used to identify APS PDUs.

11. The method of claim 9 wherein said indication of said identity for said trunk is a real service's Service Instance Identifier combined with a special media access control (MAC) source address for said trunk and a MAC destination address for said trunk.

12. At a first bridge at a first end point of a trunk, said trunk having a primary path and a secondary path to a second bridge at a second end point of said trunk, a method of facilitating protection switching comprising:
composing an automatic protection switching protocol data unit (APS PDU);
encapsulating said APS PDU with a Service Instance Tag, thereby creating an encapsulated APS PDU, where said Service Instance Tag (I-TAG) includes an indication of an identity for said primary path; and
transmitting said encapsulated APS PDU to a second bridge at a second end point of said trunk over a secondary path to said second bridge.

13. The method of claim 12 wherein said indication of said identity for said trunk is a special Service Instance Identifier (I-SID), where special Service Instance Virtual Identifier (I-SID) can solely be used to identify APS PDUs.

14. The method of claim 12 wherein said indication of said identity for said trunk is a real service's Service Instance Identifier (I-SID) combined with a special media access control (MAC) source address for said trunk and a MAC destination address for said trunk.
